(19) United States
(12) Patent Application Publication
(10) Pub. No.: US 2026/0240135 A1
(43) Pub. Date: Aug. 20, 2026

(54) MOUNTING SYSTEM FOR BOAT ACCESSORIES

(71) Applicant: Brian D. Londeree, Bradenton, FL (US)

(72) Inventor: Brian D. Londeree, Bradenton, FL (US)

(21) Appl. No.: 18/885,867

(22) Filed: Sep. 16, 2024

(51) Int. Cl. A01K 97/10; A01K 97/04; A01K 97/22; B63B 17/00

(52) U.S. Cl. CPC A01K 97/10; B63B 17/00; A01K 97/04; A01K 97/22; B63B 2017/0054

(57) ABSTRACT

A mounting system (1) for boat accessories (2) that allows an accessory to be temporarily mounted to two or more existing rod holders (5) on a boat's gunnel (6). In addition, the mounting system provides substitute rod holders (13) to replace the existing rod holders on a boat while the existing rod holders are being used to support an accessory.

### FIELD OF THE INVENTION

The present invention relates to boating and, more particularly, to a mounting system that allows an accessory, such as a bait cutting table, to be removably mounted in two or more existing rod holders on a boat gunnel.

### BACKGROUND OF THE INVENTION

Conventional marine accessories include bait cutting tables, serving tables, barbeque grills, and so forth. These accessories typically have a single vertical support that may be inserted into a rod holder on a boat gunnel. This allows accessories to be temporarily mounted at a convenient height and location on the boat gunnel.

However, the use of a single vertical support has drawbacks that could be solved by adding a second vertical support. Unfortunately, the spacing between rod holders differs from boat to boat, thus, the use of a second vertical support would require a boat owner to drill and install an additional rod holder to accommodate the spacing of the two vertical supports.

In additional problem presented by such accessories is the loss of available rod holders on the boat.

Therefore, a need exists for an adjustable mounting system that that is customizable to different spacings found between existing rod holders on boat gunnels; and a mounting system that provides substitute rod holders to replace the rod holders being used to support the accessory.

The relevant prior art includes the following references:

| Patent No. | Inventor | Issue/Publication Date |
|---|---|---|
| 2007/0178820 | Tylman | Aug. 2, 2007 |
| 9,821,888 | Gulino et la. | Nov. 21 2017 |
| 9,901,218 | Fill | Feb. 27, 2018 |
| 10,801,665 | Casagrande | Oct. 13, 2020 |
| 2011/0209645 | Albornoz Pinzon et al. | Sep. 1, 2011 |
| D859,040 | Williamson | Sep. 10, 2019 |

### SUMMARY OF THE INVENTION

The primary object of the present invention is to provide a mounting system for boat accessories that allows an accessory to be temporarily mounted to two or more existing rod holders on a boat's gunnel.

An additional object of the present invention is to provide a mounting system that provides substitute rod holders to replace the existing rod holders on a boat when the existing rod holders are being used to support an accessory.

The present invention fulfills the above and other objects by providing a mounting system for boat accessories, such as cutting boards, tables, barbeque grills, and so forth, wherein the accessory is mounted using at least two tubular vertical supports wherein bottom ends of the vertical supports are inserted into existing rod holders on a boat. Top ends of the vertical supports attach to at least one horizontal sliding bracket wherein the distance between the vertical supports may be increased or decreased to match a distance between existing rod holders on a boat. The top ends of the vertical supports may be locked into position on the sliding bracket and accessory to lock the vertical supports in place on the accessory.

In addition, the mounting system provides substitute rod holders that extend from the vertical supports and are held in raised positions behind the supported accessory for easy access.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front plan view of a bait table accessory being supported by a mounting system of the present invention;

FIG. 2. is a front perspective view of two vertical supports of the present invention inserted into two existing rod holders on a boat gunnel;

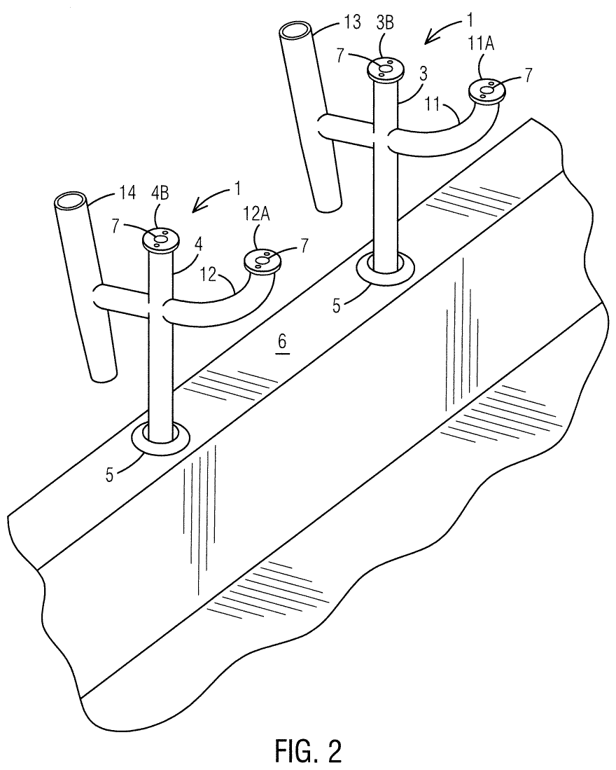

FIG. 3 is a side view of a bait table accessory being supported by a mounting system of the present invention; and

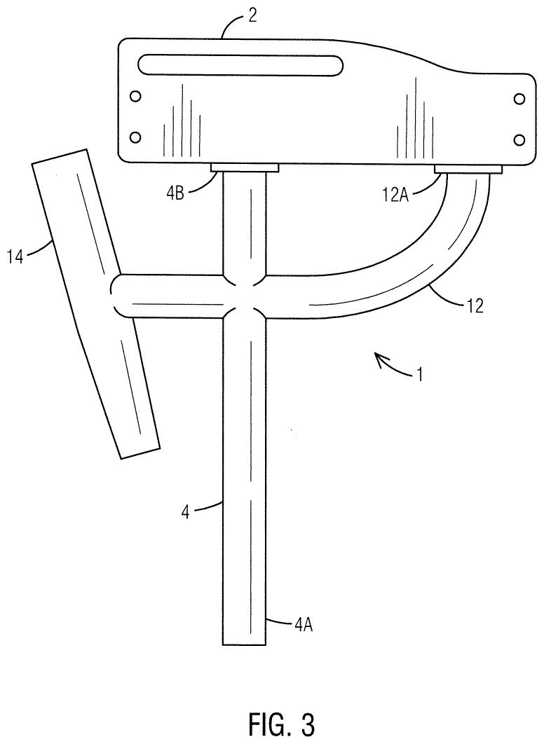

FIG. 4 is a top view of a bait table accessory being supported by a mounting system of the present invention.

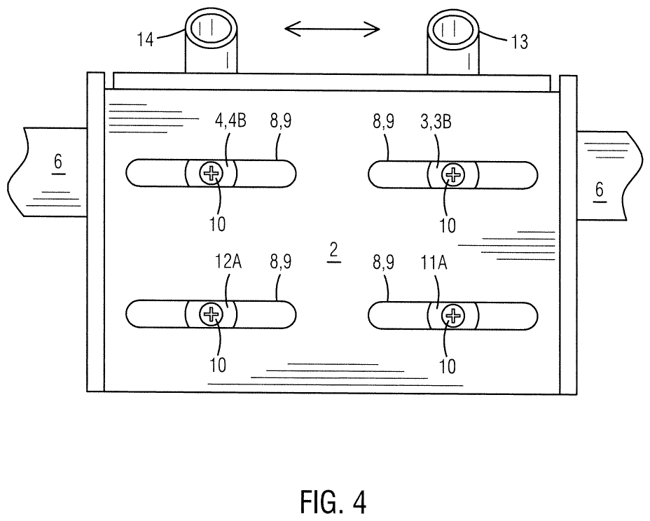

### DESCRIPTION OF THE PREFERRED EMBODIMENTS

For purposes of describing the preferred embodiment, the terminology used in reference to the numbered accessories in the drawings is as follows:
1. mounting system, generally
2. accessory
3. first vertical support
3A. bottom end
3B. top end
4. second vertical support
4A. bottom end
4B. top end
5. existing rod holder
6. boat gunnel
7. bolt hole
8. adjustable bracket
9. slot
10. bolt
11. first front support
11A. top end
12. second front support
12A. top end
13. first substitute rod holder
14. second substitute rod holder

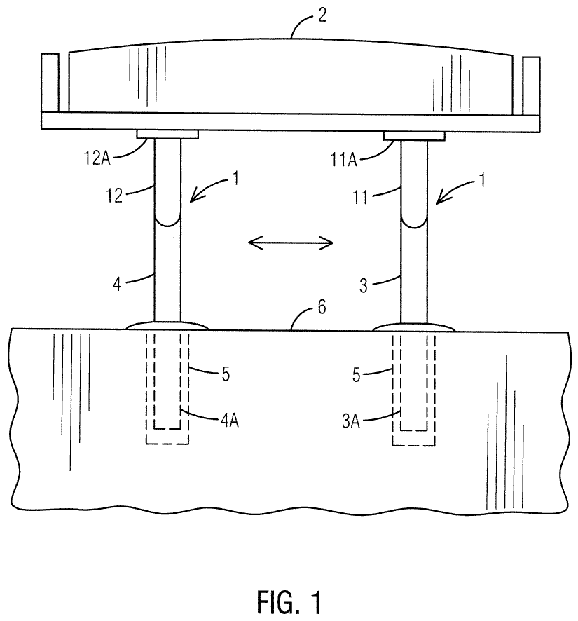

With general reference to FIG. 1, a perspective view of a bait table accessory 2 being supported by a mounting system 1 of the present invention. The mounting system 1 comprises a first vertical support 3 and a second vertical support 4 each having bottom ends 3A, 4A that are inserted into existing rod holders 5 on a boat gunnel 6. Top ends 3B, 4B of the vertical supports 3, 4 each comprise an attachment means, such as threaded bolt holes 7, that are respectively attached to one or more adjustable brackets 8 located on or integrated into the accessory 2. As illustrated herein, the adjustable brackets 8 each comprise a slot 9 and bolt 10 that allow the vertical supports 3, 4 to be positioned and locked into place on the accessory 2 at a width that matches a width between two existing rod holders 5 on a boat gunnel 6. Front supports 11, 12 extend forwardly from the vertical supports 3, 4, respectively, and provide top ends 11A, 12A with additional attachment means, such as threaded bolt holes 7, located thereon.

In addition, the mounting system 1 provides substitute rod holders 13, 14 that extend rearwardly from the vertical supports 3, 4, respectively, and are held in raised positions behind the supported accessory 2 for easy access.

As illustrated herein, the vertical supports 3, 4 are straight, however, the vertical supports 3, 4 may also have offset bends to provide additional distance between the top ends 3B, 4B of the vertical supports 3, 4 when mounting larger accessories 2.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A boating accessory and mounting system comprising:
a boating accessory having a bottom surface to which a mounting system is attachable wherein said mounting system comprises a first vertical support and a second vertical support;
said first vertical support having a top end that is slidably attached to the bottom surface of said boating accessory;
said first vertical support having a top end that is slidably attached to the bottom surface of said boating accessory;
said first vertical support having a bottom end that may be inserted into a first rod holder;
said second vertical support having a bottom end that may be inserted into a second rod holder; and
wherein a distance between the first leg and the second leg may be adjusted to match a distance between the first rod holder and the second rod holder.

2. The boating accessory and mounting system of claim 1 wherein:
said first rod holder further comprises a substitute rod holder extending therefrom.

3. The boating accessory and mounting system of claim 1 wherein:
said second rod holder further comprises a substitute rod holder extending therefrom.

4. A vertical support used to mount an accessory to a fishing rod holder, said vertical support comprising:
a tubular body having a top end and a bottom end;
said top end having an attachment means located thereon for securing the top end thereof to a bottom surface of a boating accessory;
said bottom end being capable of being inserted into an existing fishing rod holder; and
a substitute fishing rod holder extending rearwardly from the top end of the vertical support and held in a raised position.

5. The vertical support of claim 1 further comprising:
a front support extending forwardly from the vertical support and having a top end with an attachment means located thereon for securing the top end thereof to the bottom surface of a boating accessory.

6. A boating accessory mounting system comprising:
a work surface configured for use on a boat;
a first support member and a second support member coupled to the work surface;
wherein each support member includes a lower mounting portion configured to be removably received within a corresponding mounting receptacle on a boat;
wherein the support members are adjustably coupled to the work surface such that a spacing between the support members is selectively adjustable to accommodate different mounting receptacle spacings on different boats; and
wherein the work surface is configured to be removably mounted to the boat by the first and second support members.

7. The mounting system of claim 6, wherein at least one of the support members is adjustable relative to the work surface in a fore-and-aft direction.

8. The mounting system of claim 6, wherein at least one of the support members is vertically adjustable relative to the work surface.

9. The mounting system of claim 6, wherein the work surface is angularly adjustable relative to at least one support member to selectively control drainage from the work surface.

10. The mounting system of claim 6, wherein the support members are coupled to the work surface by adjustable brackets having elongated slots permitting selective lateral positioning of the support members.

11. The mounting system of claim 10, wherein fasteners extend through the elongated slots to lock the support members in selected positions.

12. A removable marine work table system comprising:
a table surface;
a pair of depending support legs attached to the table surface;
wherein the support legs are repositionable relative to the table surface to align with spaced mounting receptacles on different boats; and
wherein the support legs are configured to removably engage the mounting receptacles to support the table surface above a transom or gunwale of the boat.
